(19) United States
(12) Patent Application Publication
(10) Pub. No.: US 2022/0192182 A1
(43) Pub. Date: Jun. 23, 2022

(54) APPARATUS TO PRESERVE AND TRANSPORT BIOLOGICAL SAMPLES AT CRYOGENIC CONDITIONS

(71) Applicant: TMRW Life Sciences, Inc., New York, NY (US)

(72) Inventors: Brian Joseph Bixon, Jersey City, NJ (US); Chengxi Li, Jersey City, NJ (US)

(21) Appl. No.: 17/552,327

(22) Filed: Dec. 15, 2021

Related U.S. Application Data
(60) Provisional application No. 63/128,732, filed on Dec. 21, 2020.

(51) Int. Cl. A01N 1/02

(52) U.S. Cl. CPC A01N 1/0257

(57) ABSTRACT

A specimen transporter includes a housing and a lid attached so as to enable a transition of the specimen transporter from a closed configuration, in which an internal cavity of the housing is thermally isolated from an exterior of the specimen transporter, to an open configuration, in which the internal cavity is accessible via an opening of the housing. The specimen transporter includes a thermal shunt positioned within the internal cavity so as to evenly distribute heat within the internal cavity. The specimen transporter includes a carrier to support one or more specimen containers each carrying a respective biological sample to be transported.

### BACKGROUND

### Technical Field

The present disclosure generally relates to systems to transport and preserve collected biological samples (e.g., eggs, sperm, embryos), and more specifically to an apparatus capable of transporting multiple collected biological samples while at least temporarily maintaining the collected samples at cryogenic temperatures.

### Description of the Related Art

Long-term preservation of cells and tissues through cryopreservation has broad impacts in multiple fields including tissue engineering, fertility and reproductive medicine, regenerative medicine, stem cells, blood banking, animal strain preservation, clinical sample storage, transplantation medicine, and in vitro drug testing. This can include the process of vitrification in which a biological sample (e.g., an oocyte, an embryo, a biopsy) contained in or on a storage device (e.g., a cryopreservation straw, cryopreservation tube, stick or spatula) is rapidly cooled by placing the biological sample and the storage device in a substance, such as liquid nitrogen. This results in a glass-like solidification or glassy state of the biological sample (e.g., a glass structure at the molecular level), which maintains the absence of intracellular and extracellular ice (e.g., reducing cell damage and/or death) and, upon thawing, improves post-thaw cell viability. To ensure viability, the vitrified biological samples are then typically continuously stored in a liquid nitrogen dewar or other container, which is at a temperature conducive to cryopreservation, for example negative 196 degrees Celsius.

There are, however, a number of concerns in how these biological samples are being collected, transported, stored, identified, managed, inventoried, retrieved, etc.

For example, each harvested embryo is loaded on a rigid embryo straw, tube, stick or spatula. The tube may be open at one end that receives the harvested embryo and closed (e.g., plugged) at the other end. The cryopreservation storage devices containing or holding the embryos are cooled as quickly as possible by plunging the cryopreservation storage device with the biological material into liquid nitrogen at a temperature of approximately negative 196 degrees Celsius, for example to achieve vitrification.

More particularly, multiple cryopreservation storage devices are placed in a goblet for placement in the liquid nitrogen storage tank. The goblet attaches to the liquid nitrogen storage tank such that the multiple cryopreservation storage devices are suspended in the liquid nitrogen.

The location at which the biological samples are collected/harvested is typically remote from the location of the liquid nitrogen storage tanks. Accordingly, it is desirable to provide a new apparatus for transporting and preserving biological samples (e.g., vitrified biological samples) at suitably cold temperatures.

### BRIEF SUMMARY

According to one aspect of the disclosure, a specimen transporter includes a housing, a lid, and a thermal shunt. The housing includes a floor and a sidewall. The sidewall extends from the floor toward an opening of the housing bounded by a mating surface of the housing. The lid is coupleable to the housing such that a mating surface of the lid and the mating surface of the housing cooperatively close the opening thereby preventing ingress to or egress from an internal cavity of the housing formed by the floor and the sidewall. The thermal shunt is coupled to the sidewall and positioned within the internal cavity, and the thermal shunt includes a material that has a higher thermal conductivity than the sidewall.

According to another aspect of the disclosure, a method of collecting a biological specimen includes positioning the biological specimen on a surface of a specimen container. The method further includes filling at least a portion of an internal cavity of a specimen transporter with a coolant thereby at least partially submerging a thermal shunt positioned within the internal cavity. The method further includes positioning the specimen container with the biological specimen within the internal cavity, and at least partially submerging the specimen container in the coolant.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a top, front, isometric view of a specimen transporter, according to an embodiment, in a closed configuration.

FIG. 2 is a top, front, isometric view of the specimen transporter illustrated in FIG. 1, in an open configuration.

FIG. 3 is a bottom, rear, isometric view of the specimen transporter illustrated in FIG. 1.

FIG. 4 is a front, elevation view of the specimen transporter illustrated in FIG. 1.

FIG. 5 is a first side, elevation view of the specimen transporter illustrated in FIG. 1.

FIG. 6 is a second side, elevation view of the specimen transporter illustrated in FIG. 1.

FIG. 7 is a rear, elevation view of the specimen transporter illustrated in FIG. 1.

FIG. 8 is a top, plan view of the specimen transporter illustrated in FIG. 1.

FIG. 9 is a bottom, plan view of the specimen transporter illustrated in FIG. 1.

FIG. 10 is a cross-sectional view of the specimen transporter illustrated in FIG. 1, along line A-A.

FIG. 11 is a cross-sectional view of the specimen transporter illustrated in FIG. 1, along line B-B.

FIG. 12 is an isometric view of a carrier of the specimen transporter, according to one embodiment.

FIG. 13 is a flow diagram showing a method of collecting a biological sample, according to an embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with specimen transporters have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” “an embodiment,” or “an aspect of the disclosure” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure.

The headings and Abstract of the Disclosure provided herein are for convenience only and do not interpret the scope or meaning of the embodiments.

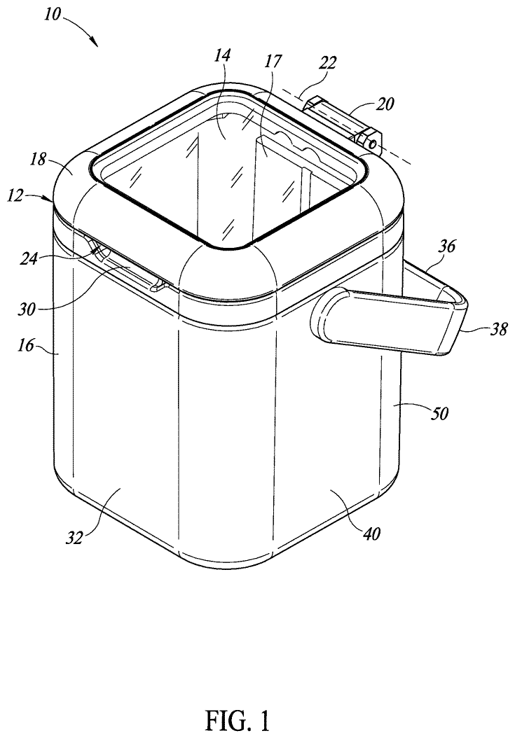

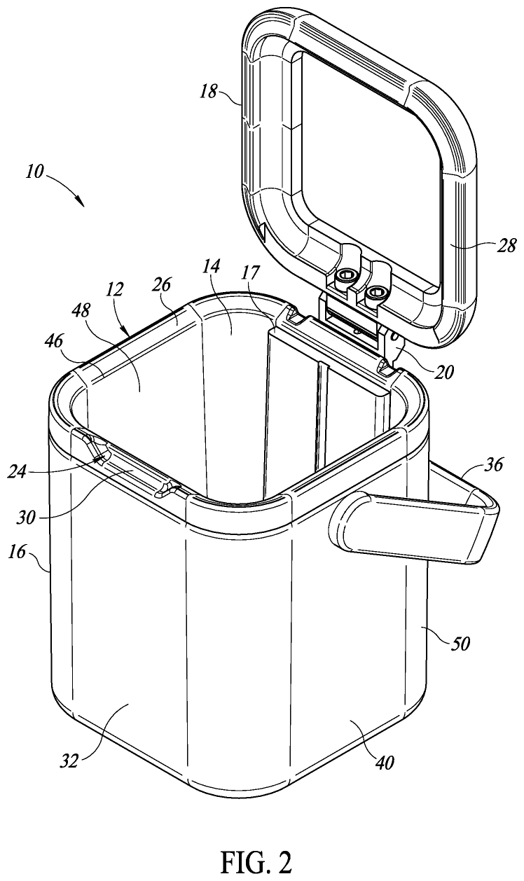

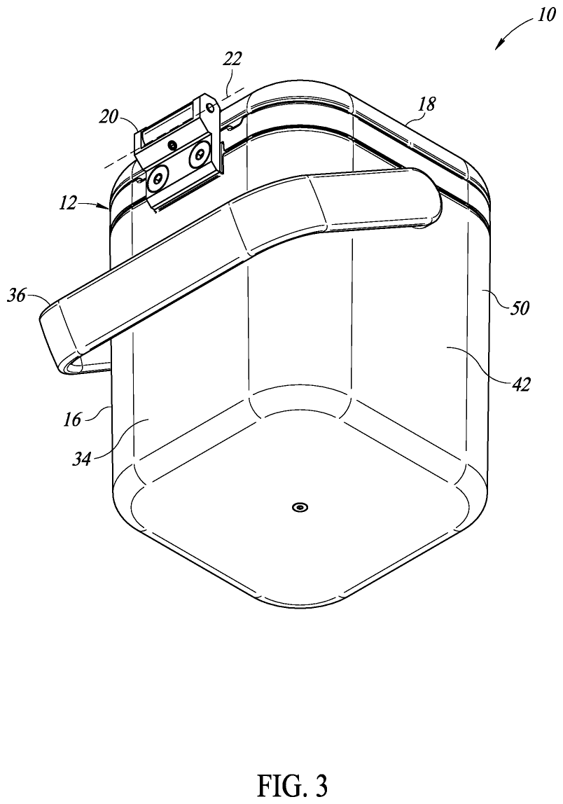

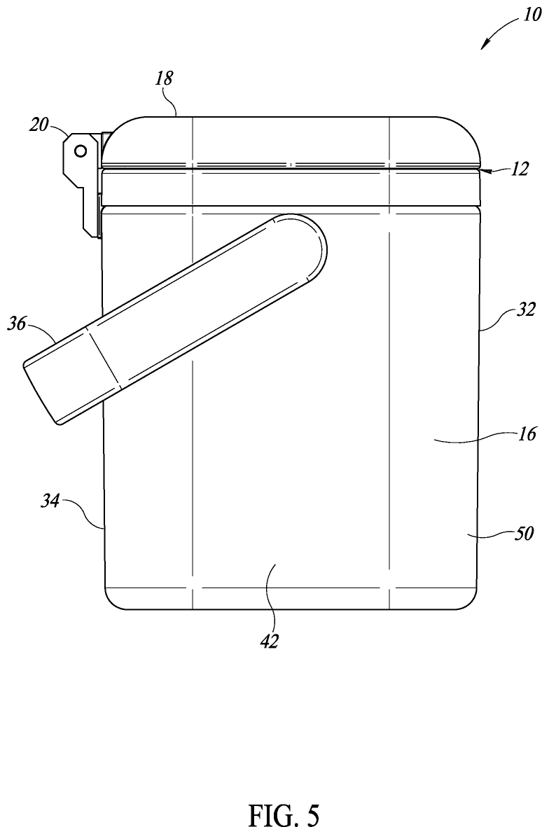

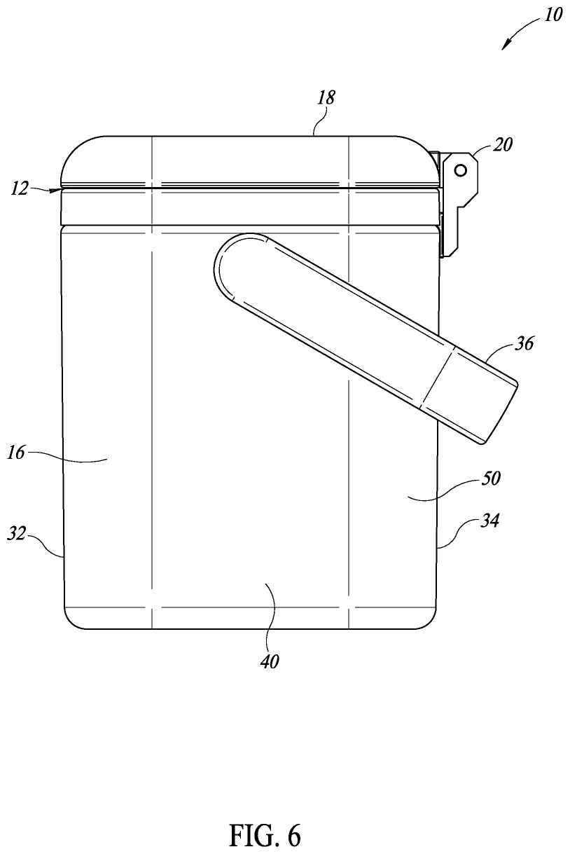

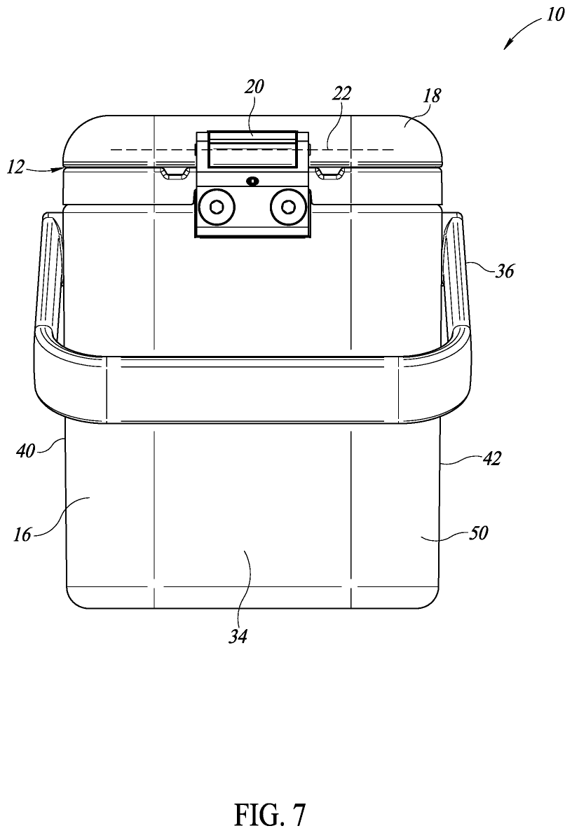

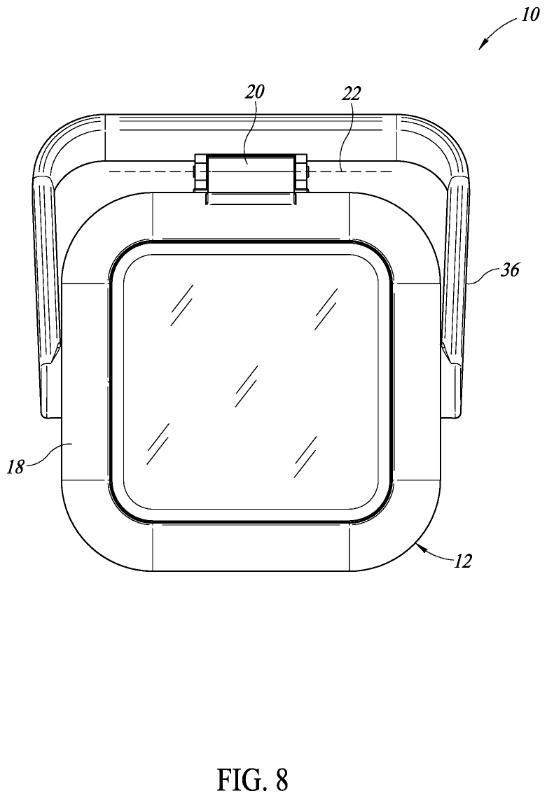

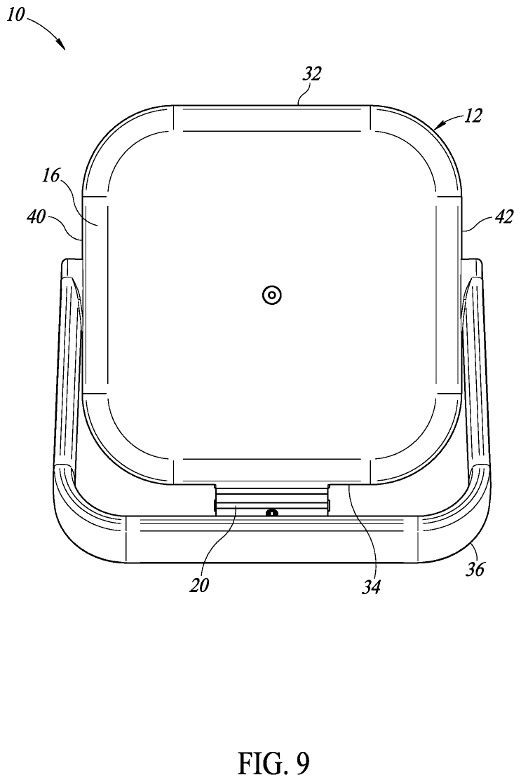

Referring to FIGS. 1 to 9, a specimen transporter 10 includes a body 12 that selectively encloses an internal cavity 14 formed by the body 12. The body 12 can include a housing 16 and a lid 18. The housing 16 and the lid 18 are attached so as to enable a transition of the specimen transporter 10 from a closed configuration (as shown in FIG. 1) to an open configuration (as shown in FIG. 2). As shown in the illustrated embodiment, in the closed configuration the internal cavity 14 is sealed off from an exterior (e.g., the surrounding environment) of the specimen transporter 10, and in the open configuration the internal cavity 14 is accessible from the exterior of the specimen transporter 10.

According to one embodiment, the housing 16 and the lid 18 may be permanently coupled, (i.e., such that the lid 18 cannot be completely separated from the housing 16 without plastically deforming the body 12. For example, the body 12 may include a hinge 20, which movable couples the housing 16 and the lid 18. As shown in the illustrated embodiment, the hinge 20 may enable rotation of the lid 18 with respect to the housing 16 about an axis of rotation 22. According to one embodiment, rotation of the lid 18 relative to the housing 16 in a first rotational direction about the axis of rotation 22 transitions the specimen transporter 10 from the closed configuration to the open configuration. Similarly, rotation of the lid 18 relative to the housing 16 in a second rotational direction (opposite the first rotational direction) about the axis of rotation 22 transitions the specimen transporter 10 from the open configuration to the closed configuration.

According to one embodiment, the housing 16 and the lid 18 may be separable without plastically deforming the body 12. For example, the housing 16 and the lid 18 may include corresponding mating features (e.g., corresponding threads, projection and recess, friction fit).

The body 12 may include a lock (not shown) that, while engaged, prevents movement of the lid 18 relative to the housing 16, when the specimen transporter 10 is in the closed configuration. The lock may be disengaged to enable transition of the specimen transporter 10 from the closed configuration to the open configuration. Thus, the lock may prevent unintended exposure of the internal cavity 14 to the surrounding environment.

The body 12 may include an open assist feature 24. When in the closed configuration a mating surface 26 of the housing 16 and a mating surface 28 of the lid 18 may be pressed tightly together such that purchase or grip between the housing 16 and the lid 18 is difficult. According to one embodiment, one or both of the housing 16 and the lid 18 may include one or both of a recess 30 and a projection (not shown). As shown in the illustrated embodiment, the open assist feature 24 includes the recess 30 formed in the housing 16.

According to one embodiment, the open assist feature 24 may be located opposite the hinge 20. As shown in the illustrated embodiment, the open assist feature 24 may be located at a front of the body 12, for example on a front surface 32 of the housing 16, and the hinge 20 may be located at a rear of the body 12, for example on a rear surface 34 of the housing 16.

The body 12 may include a handle 36 that facilitates lifting the specimen transporter 10, for example by a human hand(s). The handle 36 may take the form of a rigid member 38. As shown in the illustrated embodiment, the rigid member 38 may be a U-shaped member. The handle 36 may be rotatably attached to the body 12, for example to a first side surface 40 of the housing 16 and a second side surface 42 of the housing 16, as shown.

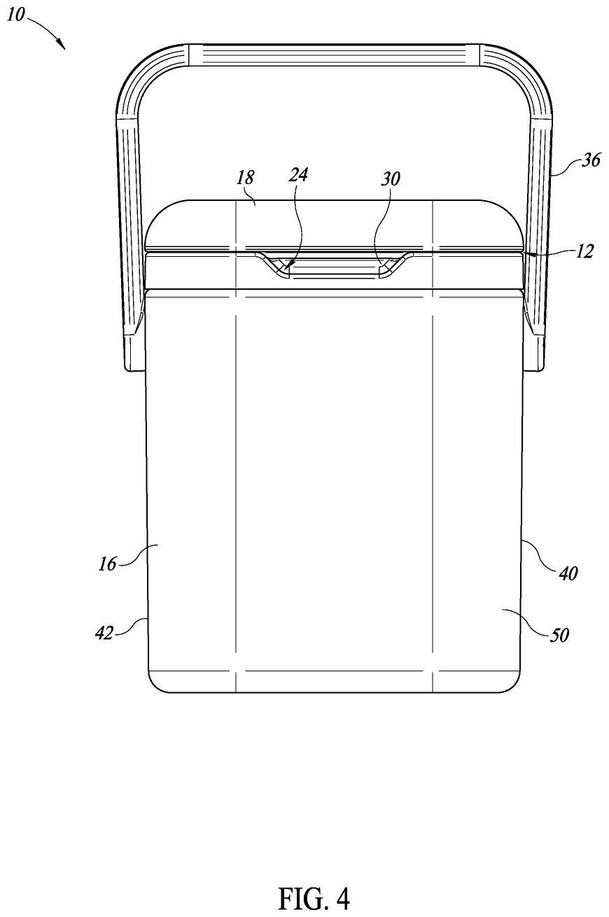

The handle 36 may be rotatable into an “up” position (as shown in FIG. 4) to facilitate lifting and carrying of the specimen transporter 10. According to one embodiment, when in the “up” position there may be enough clearance between the handle 36 and the lid 18 to allow passage of fingers of a user of the specimen transporter 10. The handle 36 may be rotatable into a “down” position in which the handle does not interfere with movement of the lid 18 (i.e., during transition from the closed configuration to the open configuration).

The handle 36 may take other forms. For example the handle 36 may be fixed relative to the housing 16 and the lid 18. The handle 36 may be in the form of a depression, or textured surface, for example in one or both of the first side surface 40 and the second side surface 42. The handle 36 may be a non-rigid member (i.e., a belt, a strap, etc.).

Referring to FIGS. 1-2 and 10-11, the specimen transporter 10 may include a thermal shunt 17 positioned within the internal cavity 14. The thermal shunt 17 may include a material with a high thermal capacity (ability to store thermal energy). Materials with a higher thermal capacity require more energy for a given temperature change than a material with a lower thermal capacity. Thermal capacity for a given material can be calculated by multiplying the volume times the density times the specific heat times the temperature change. When comparing the thermal capacity of two different materials, if the volume and the temperature change for the two materials is the same, the densities and the specific heats of the two materials determines the relative thermal capacities of the two materials.

For example, aluminum 6061-T6 at room temperature has a specific heat capacity of about 897 J/(kg K) and a density of about 2,700 kg/m³. Comparatively, polyphenylsulfone (PPSU) at room temperature has a specific heat capacity of about 970 J/(kg K) and a density of about 1,290 kg/m³. Thus, the thermal capacity of a volume of aluminum 6061-T6 is about double the thermal capacity of an equal volume of polyphenylsulfone.

The thermal shunt 17 may include a material with a relatively high thermal conductivity. The high thermal conductivity will improve the speed at which a cold temperature (for example provided by the coolant) is spread to a portion of the internal cavity 14 remote from the coolant. Metals typically have high thermal conductivity values, (e.g., aluminum 6061-T6 at room temperature has a thermal conductivity of about 152 W/(m−K)). Gases and foams typically have low thermal conductivity values, (e.g., polyphenylsulfone at room temperature has a thermal conductivity of about 0.24 W/(m−K)).

As shown in the illustrated embodiment, the thermal shunt 17 may be positioned such that a height H1 of the thermal shunt 17 extends vertically (between a floor 44 of the housing 16 and an opening 46 of the housing 16, which provides access into the internal cavity 14). According to one embodiment, the floor 44 includes the lowest surface of the housing 16 that bounds the internal cavity 14. According to one embodiment, the opening 46 is bounded by the highest surface of the housing 16, for example the mating surface 26.

The thermal shunt 17 may include a material that has a relatively high thermal conductivity, for example compared to other materials present in the housing 16. The thermal shunt 17 may be sized and positioned so as to evenly distribute heat within the internal cavity 14 (i.e., preventing localized “hot spots”). As shown in the illustrated embodiment, the height H1 of the thermal shunt 17 is at least 50% of a height H2 of the housing 16. The height of the housing H2 may be measured from the lowest surface of the housing 16 that bounds the internal cavity (e.g., the floor 44) to the highest surface of the housing (e.g., the opening 46), as shown. According to one embodiment, the height H1 of the thermal shunt 17 is at least 75% of the height H2 of the housing 16. According to one embodiment, the height H1 of the thermal shunt 17 is at least 90% of the height H2 of the housing 16.

The housing 16 may include an inner sidewall 48 that bounds the internal cavity 14 and extends between the floor 44 and the mating surface 26. One or both of the floor 44 and the inner sidewall 48 may include a thermally insulative material, (e.g., a material with a low thermal conductivity value). The material(s) for the inner sidewall 48 and the floor 44 may have a lower thermal capacity than the thermal shunt 17. According to one embodiment, the material(s) for the housing 16 are selected based on their structural integrity at cryogenic temperatures, and/or for their low thermal contraction rate. For example, at least one of the inner sidewall 48 and the floor 44 may be made from polyphenylsulfone. According to one embodiment, the floor 44 and the inner sidewall 48 are made from the same material.

The housing 16 may include a double wall to improve thermal insulation of the internal cavity 14. As shown, the housing 16 may include an outer sidewall 50 that includes the front surface 32, the rear surface 34, the first side surface 40, and the second side surface 42 of the housing 16. The housing 16 may include one or more gaps 52 between the inner sidewall 48 and the outer sidewall 50, according to one embodiment. The gap 52 may enclose a vacuum, air, or insulation.

The housing 16 may include an offset 54. As shown, the offset 54 extends from the floor 44 vertically into the internal cavity 14 toward the opening 46. The offset 54 may be remote from the inner sidewall 48, as shown in the illustrated embodiment. According to another embodiment, the offset 54 may extend horizontally from the inner side wall 48. The offset 54 may be sized to contact and support a carrier 110 that holds one or more specimen containers 210. According to one embodiment, the offset 54 maintains a gap 60 between the carrier 110 and the floor 44 so that coolant, for example liquid nitrogen, within the internal cavity 14 fills the gap 60. According to one embodiment, the coolant may fill roughly two-thirds of a height of the internal cavity 14. The specimen containers 210 may carry a biological specimen 212 in a portion of the specimen container 210 that sits within or near the gap 60, thus positioning the carried biological specimen 212 within close proximity to the coolant. According to another embodiment, the housing 16 may be devoid of the offset 54, such that the carrier 110 sits directly on the floor 44.

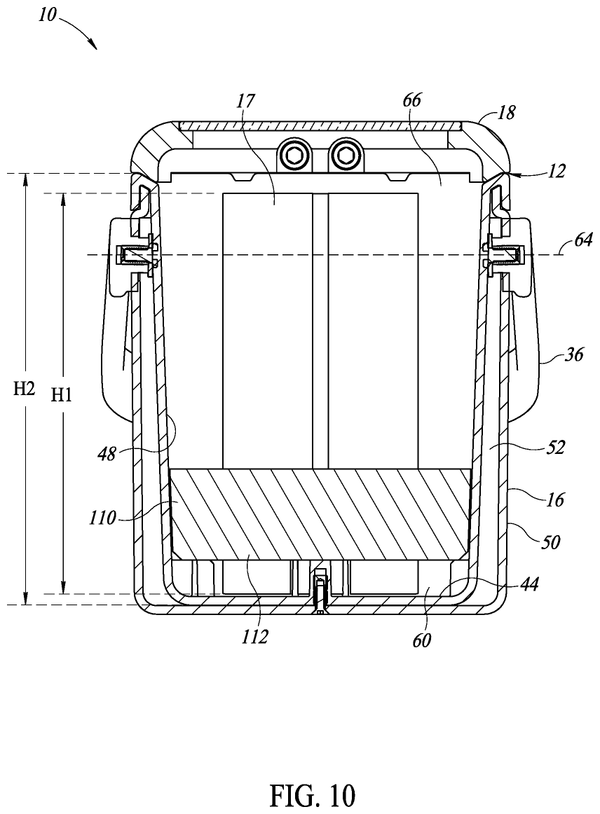

Referring to FIGS. 10 to 12, the carrier 110 may include a frame 112 with a plurality of through holes 113, each of the through holes 113 sized to retain a respective one of the specimen containers 210 such that when positioned within one of the through holes 113 relative movement of the specimen container 210 and the housing 16 is restricted. The through holes 113 may be arranged linearly (e.g., a row of two or more) or in an array (e.g., a 7 by 7 grid).

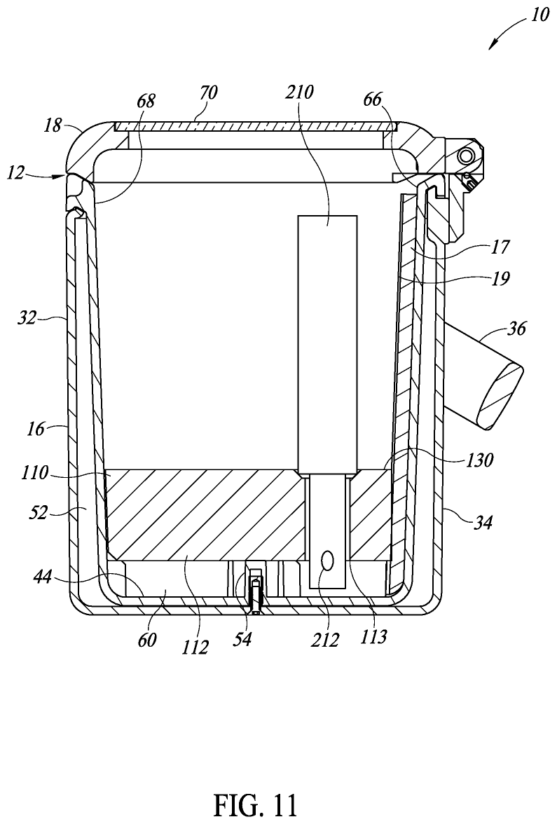

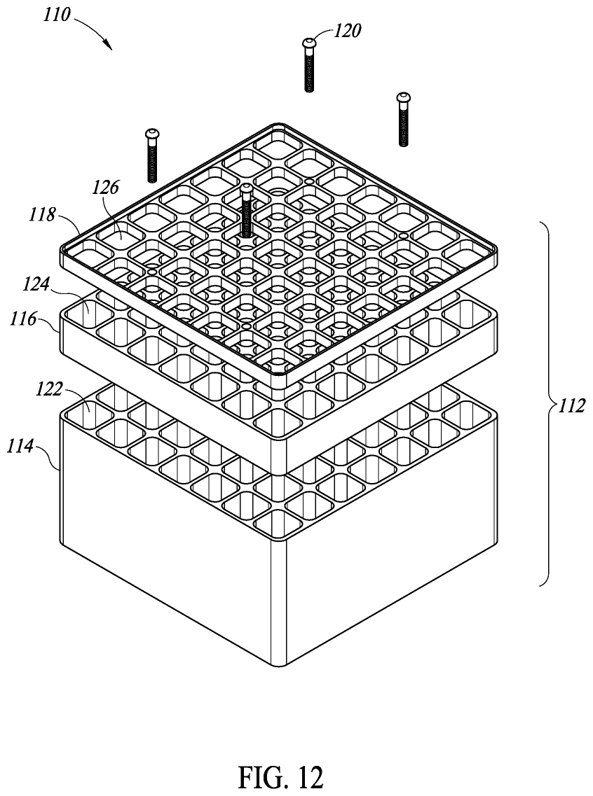

As shown in FIGS. 10 and 11, the carrier 110 may include the frame 112 formed from a single, monolithic substrate. As shown in FIG. 12, the carrier 110 may include the frame 112 formed from a plurality of discrete substrates. For example, the frame 112 may include a first substrate 114, a second substrate 116, and a third substrate 118. The first, second, and third substrates 114, 116, and 118 may be stacked such that the second substrate 116 is above the first substrate 114, and the third substrate 118 is above the second substrate 116. The first, second, and third substrates 114, 116, and 118 may be secured, for example with fasteners such as screws 120.

The first, second, and third substrates 114, 116, and 118 may be formed from different materials. For example, the first substrate 114 may be a thermally conductive material, such as aluminum 6061-T6. The second substrate 116 may be an insulator, such as polyvinylidene fluoride (PVDF). The third substrate may be a polymer, such as Polyphenylsulfone (PPSU).

The first substrate 114 may include a first plurality of through holes 122, the second substrate 116 may include a second plurality of through holes 124, and the third substrate 118 may include a third plurality of through holes 126. When the first, second, and third substrates 114, 116, and 118 are stacked and secured the first, second, and third pluralities of through holes 122, 124, and 126 may be aligned so as to cooperatively define through holes that extend through an entirety of the frame 112. The first, second, and third pluralities of through holes 122, 124, and 126 may be arranged linearly (e.g., a row of two or more) or in an array (e.g., a 7 by 7 grid).

The through holes 113, 122, 124, and 126 may define a cross-sectional shape that corresponds to a shape of the specimen containers 210 to be received within the through holes. According to one embodiment the cross-sectional shape is non-circular such that rotation of the specimen containers 210 within the through holes is prevented. According to another embodiment the cross-sectional shape is circular.

The frame 112 may include one or more surfaces with a shape that corresponds to a shape of the thermal shunt 17. For example, the frame 112 may include a projection 130 that corresponds to a groove 19 of the thermal shunt 17 that facilitates alignment and positioning of the carrier 110 within the internal cavity 14.

Referring to FIGS. 10 and 11, according to one embodiment, the thermal shunt 17 may be positioned such that a portion of the thermal shunt 17, for example a bottom surface of the thermal shunt 17 is closer to the floor 44 than a top portion of the offset 54, for example a surface of the offset that abuts the carrier 110. Thus, a portion of the thermal shunt 17 may be positioned within the gap 60.

According to one embodiment, the handle 36 is rotatable relative to the housing 16 about an axis of rotation 64. As shown, the thermal shunt 17 may be positioned such that a portion of the thermal shunt 17, for example a top surface of the thermal shunt 17 is closer to the opening 46 than the axis of rotation 64 is from the opening 46.

The thermal shunt 17 may be in the form of a plate, for example constructed from a thermally conductive metal, such as but not limited to Aluminum 6061-T6. The thermal shunt 17 may include one or more grooves, cavities, tubes, etc. formed in the material to further promote even heat distribution within the internal cavity 14. As shown, the thermal shunt 17 may be attached to a rear surface 66 of the inner sidewall 48, wherein the rear surface 66 includes the portion of the inner sidewall 48 closest to the rear surface 34 of the housing 16. Alternatively, the thermal shunt 17 may be attached to a front surface 68 of the inner sidewall 48, wherein the front surface 68 includes the portion of the inner sidewall 48 closest to the front surface 32 of the housing 16. The thermal shunt 17 may be attached to one or both sides of the inner sidewall 48. Although only one thermal shunt 17 is shown in the illustrated embodiment, according to another embodiment multiple thermal shunts 17 may be included within the internal cavity 14. According to one embodiment, the thermal shunt 17 may be incorporated into the inner sidewall 48 (i.e., a coating on at least a portion of the inner sidewall 48.)

The lid 18 may include a transparent portion 70 that allows elements (e.g., the specimen containers 210) within the internal cavity 14 to be visible from the exterior of the specimen transporter 10 when the specimen transporter 10 is in the closed configuration.

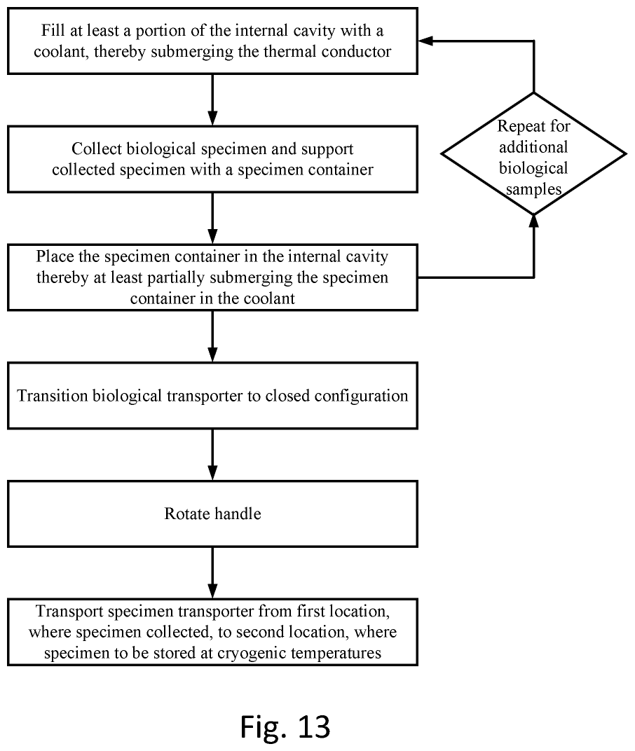

Referring to FIGS. 1 to 13, a method of transporting a biological specimen includes collecting the biological specimen 212 and carrying the collected biological specimen 212 with a specimen container 210. According to one embodiment, the collecting the biological specimen 212 with the specimen container 210 includes enclosing the biological specimen 212 within the specimen container 210. The method may further include filling at least a portion of the internal cavity 14 with a coolant. Filling at least a portion of the internal cavity 14 with the coolant may include at least partially submerging the thermal shunt 17. The method may further include at least partially submerging the specimen container 210 in the coolant that is within the internal cavity 14 of the specimen transporter 10. According to one embodiment, the coolant is liquid nitrogen.

The method may further include supporting the specimen container 210 with the carrier 110, wherein the carrier 110 is positioned within the internal cavity 14. The collecting and at least partially submerging of the biological specimen 212, in addition to the supporting of the specimen container 210 may be repeated for a plurality of biological specimen.

According to one embodiment, the carrier 110 contacts the thermal shunt 17. The method may further include transitioning the specimen transporter 10 to the closed configuration such that the internal cavity 14 is thermally isolated from the exterior of the specimen transporter 10. Transitioning the specimen transporter 10 to the closed configuration may include rotating the lid 18 relative to the housing 16 until the mating surfaces 26 and 28 meet.

The method may include rotating the handle 36 about the axis of rotation 64 until the handle 36 is positioned above the lid 18, and then lifting the specimen transporter 10 by the handle 36. The method may further include transporting the specimen transporter 10 from a first location at which the biological specimen 112 was collected to a second location at which the biological specimen 112 will be stored at cryogenic temperatures.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

Many of the methods described herein can be performed with variations. For example, many of the methods may include additional acts, omit some acts, and/or perform acts in a different order than as illustrated or described. The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A specimen transporter comprising:
a housing including a floor and a sidewall, the sidewall extending from the floor toward an opening, the opening defined by a mating surface of the housing;
a lid coupleable to the housing such that a mating surface of the lid and the mating surface of the housing cooperatively close the opening thereby preventing ingress to or egress from an internal cavity of the housing formed by the floor and the sidewall; and
a thermal shunt coupled to the sidewall and positioned within the internal cavity,
wherein the sidewall includes a first material, and the thermal shunt includes a second material that has a higher thermal capacity than the first material given equal volumes of the first material and the second material.

2. The specimen transporter of claim 1 wherein the housing has a first height measured from the floor to the opening along a direction perpendicular to the floor, the thermal shunt has a second height measured along the direction perpendicular to the floor;
and the second height is less than the first height and greater than fifty percent of the first height.

3. The specimen transporter of claim 2 wherein the second height is less than the first height and greater than seventy-five percent of the first height.

4. The specimen transporter of claim 3 wherein the second height is less than the first height and greater than ninety percent of the first height.

5. The specimen transporter of claim 2 wherein the housing includes an offset extending from the floor towards the opening along the direction perpendicular to the floor, the offset has a maximum height with respect to the floor measured along the direction perpendicular to the floor, the thermal shunt has a minimum separation from the floor measured along the direction perpendicular to the floor, and the minimum separation is less than the maximum height.

6. The specimen transporter of claim 5, further comprising:
a carrier including a frame and at least one through hole extending through the frame, each of the at least one through holes sized to receive a specimen container,
wherein the carrier is supported within the internal cavity by the offset.

7. The specimen transporter of claim 6 wherein a first minimum distance measured between the floor and the carrier along the direction perpendicular to the floor is greater than a second minimum distance measured between the floor and the thermal shunt along the direction perpendicular to the floor.

8. The specimen transporter of claim 6 wherein a surface of the thermal shunt includes a first non-planar shape, and a surface of the carrier includes a second non-planar shape that corresponds to the first non-planar shape such that alignment of the first and second non-planar shapes facilitates alignment of the carrier within the internal cavity.

9. The specimen transporter of claim 2, further comprising:
a handle rotatably coupled to the housing such that the handle is rotatable relative to the housing about an axis of rotation,
wherein the axis of rotation is distanced from the floor by a first distance measured along the direction perpendicular to the floor, and the first distance is less than a second distance measured between the floor and a point on the thermal shunt farthest from the floor along the direction perpendicular to the floor.

10. The specimen transporter of claim 1, further comprising:
a hinge that couples the lid to the housing such that the lid is rotatable relative to the housing about an axis of rotation of the hinge,
wherein the hinge is mounted on a rear surface of the housing, and the thermal shunt is mounted on a portion of the sidewall that is closest to the rear surface.

11. The specimen transporter of claim 10 wherein the sidewall is an inner sidewall, the rear surface is part of an outer sidewall, and at least a portion of the inner sidewall is spaced from the outer sidewall by a gap.

12. The specimen transporter of claim 1 wherein at least a portion of the lid is transparent.

13. The specimen transporter of claim 1 wherein the thermal shunt is a metal plate.

14. The specimen transporter of claim 1 wherein the thermal shunt is a plate formed from aluminum 6061-T6.

15. The specimen transporter of claim 1 wherein the second material has a higher density than the first material.

16. The specimen transporter of claim 15 wherein the first material has a higher specific heat than the second material.

17. A method of collecting a biological specimen, the method comprising:
positioning the biological specimen on a surface of a specimen container;
filling at least a portion of an internal cavity of a specimen transporter with a coolant thereby at least partially submerging a thermal shunt positioned within the internal cavity;
positioning the specimen container with the biological specimen within the internal cavity; and
at least partially submerging the specimen container in the coolant.

18. The method of claim 17 wherein the coolant is liquid nitrogen.

19. The method of claim 17, further comprising:
supporting the specimen container with a carrier that is positioned within the internal cavity by inserting a portion of the specimen container through a through hole extending through a frame of the carrier.

20. The method of claim 19, further comprising:
abutting the carrier with an offset that extends from a floor of the housing such that a gap is formed between the carrier and the floor,
wherein the floor forms a bottom boundary of the internal cavity.

21. The method of claim 20 wherein abutting the carrier with the offset positions a portion of the thermal shunt within the gap.

22. The method of claim 17, further comprising:
positioning a second biological specimen on a surface of a second specimen container;
positioning the second specimen container with the second biological specimen within the internal cavity; and
at least partially submerging the second specimen container in the coolant.

23. The method of claim 17, further comprising:
transitioning the specimen transporter to a closed configuration in which a lid of the specimen transporter blocks an opening of the internal cavity thereby thermally isolating the internal cavity from an external environment surrounding the specimen transporter.

24. The method of claim 23, further comprising:
after transitioning the specimen transporter to the closed configuration, transporting the specimen transporter from a first location at which the biological specimen was collected to a second location at which the biological specimen will be stored at cryogenic temperatures.
